(19) United States
(12) Patent Application Publication
(10) Pub. No.: US 2003/0159467 A1
(43) Pub. Date: Aug. 28, 2003

(54) Method of manufacturing glass optical elements

(75) Inventors: Shinichiro Hirota, Tokyo (JP); Hiroyuki Sakai, Tokyo (JP); Takeshi Takahashi, Chiang Mai (TH)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/367,923

(22) Filed: Feb. 19, 2003

(30) Foreign Application Priority Data
Feb. 19, 2002 (JP) 2002-042287

(51) Int. Cl. C03B 40/033; C03B 11/08

(52) U.S. Cl. 65/26; 65/32.5; 65/374.15

(57) ABSTRACT

Disclosed is a method of manufacturing glass optical elements such as optical lenses by press molding. Glass optical elements of high surface precision are manufactured while preventing fusion between the pressing mold and the glass material and deterioration of the pressing mold. The method comprises supplying a glass material to a pressing mold, and press molding the glass material with the pressing mold in a non-oxidizing atmosphere and the pressing mold comprises a carbon film formed by sputtering on at least a molding surface, and the glass material comprises a carbon layer on a surface thereof. The method further comprises feeding of the glass material by dropping it onto the molding surface of a lower mold while preventing variation in the thickness of the glass optical elements.

### FIELD OF THE INVENTION

The present invention relates to a method of manufacturing glass optical elements such as optical lenses by press molding, and more particularly to a method of manufacturing glass optical elements of high surface precision by preventing fusion between the pressing mold and the glass material and deterioration of the pressing mold. Still further, the present invention relates to a method of manufacturing glass optical elements comprising the feeding of a glass material to be molded by dropping it onto the molding surface of a lower mold while preventing variation in the thickness of the glass optical elements.

### BACKGROUND OF THE INVENTION

The method of press molding at a mold temperature higher than the glass transition point using a pressing mold that has been subjected to mirror surface processing to a highly precise shape is known to yield high precision lenses not requiring polishing or grinding following pressing in a single molding. In this method, fusion of the heat-softened glass to the pressing mold becomes a problem. One proposed method of effectively preventing this is to insert a thin carbon film between the heat-softened glass and the pressing mold.

Japanese Unexamined Patent Publication (KOKAI) Showa No. 64-83529 discloses a method of manufacturing a pressing mold in which a carbon film is formed by sputtering on the base material of a pressing mold. In this manufacturing method, the base material is maintained at a temperature of 250-450° C. and an inert sputtering gas and a sputtering target made of graphite are employed to form a film. The carbon film does not contain hydrogen and the film forming temperature is comparatively high. It is described that even when the carbon film is maintained for 12 hours in a nitrogen atmosphere at 600° C. and then cooled, it maintains good adhesion to the mold surface (SiC produced by CVD in Examples) and good hardness and is superior to i-carbon films and the like formed at room temperature. Further, the use of a pressing mold on which the above-described carbon film has been formed is described to extend the number of pressings that can be conducted before fusion occurs to 200 to 300.

Japanese Unexamined Patent Publication (KOKAI) Heisei No. 2-199036 discloses a method of obtaining pressing molds by forming an i-carbon film on a mold surface at 200 to 400° C. by generating hydrocarbon ions with an ionizing source comprising an anode and a cathode by an ion-plating method.

Japanese Unexamined Patent Publication (KOKAI) Heisei No. 6-191864 describes pressing molds on which an i-carbon film has been formed by ion plating as having good heat resistance, oxidation resistance, and adhesion to the base, as well as tending not to fuse to the glass during molding. However, since the film structure is dense and the mold surface contacting the glass is highly smooth, gas (hydrogen and the like) that is discharged from the glass surface becomes trapped between the glass surface and the film surface, sometimes forming minute depressions in the molded glass surface. Further, there are problems in that fogging tends to occur and mold separation is inadequate due to tight adhesion of the glass to the highly smooth mold surface.

Further, in Japanese Unexamined Patent Publication (KOKAI) Heisei No. 6-191864, when the carbon film obtained by sputtering is formed on the mold surface, despite good beat resistance and mold separation, since it contains amorphous graphite, portions of the film sometimes tend to separate when multiple press operations are conducted at high temperature, in particular, where the press molding temperature is greater than or equal to 600° C.

Accordingly, in Japanese Unexamined Patent Publication (KOKAI) Heisei No. 6-191864, an invention is disclosed that solves the above-stated problems through a pressing mold having a carbonaceous film of dual-layered structure obtained by sequentially depositing i-carbon film and another carbon film on the processed surface of a pressing mold.

In addition to providing a thin carbon film on the molding surface as described above, methods have been proposed for inserting a thin carbon film between the heat-softened glass and the pressing mold by providing a thin carbon film on the glass.

For example, Japanese Unexamined Patent Publication (KOKAI) Heisei No. 8-217468 discloses a method of preventing fusion between a glass preform and the pressing mold by thermally decomposing acetylene to form a 10-50 Angstrom carbon film on the surface of the glass preform. However, although this publication describes reheat pressing of the glass preform, there is no disclosure of what type of pressing mold is used for reheat pressing.

Japanese Unexamined Patent Publication (KOKAI) Heisei No. 8-259241 discloses a method of press molding glass optical elements using glass blanks the surfaces of which are covered with a carbon film and a pressing mold having a molding surface of hard carbon film.

Although described further below, the hard carbon film provided on the molding surface described in Japanese Unexamined Patent Publication (KOKAI) Heisei No. 8-259241 has essential differences due to the manufacturing methods from the carbon films provided on the molding surfaces that are described in Japanese Unexamined Patent Publication (KOKAI) Showa No. 6483529 and Japanese Unexamined Patent Publication (KOKAI) Heisei No. 6-191864.

There are numerous problems deriving from various physical and chemical effects operating at the interface between the pressing mold and the lass material being molded in precision pressing of optical glass, as set forth above.

Good mold separation is required of the molding surface so that glass fusion does not occur. Use of the pressing mold disclosed in Japanese Unexamined Patent Publication (KOKAI) Showa No. 64-83529 provides some improvement in this regard. However, the number of pressings possible before fusion occurs is still inadequate.

Great force is applied on the molding surface as glass is extended and closely contacted to the molding surface of the mold, is cooled, and is separated from the mold in repeating fashion in the course of press molding at high temperature. Even when a thin carbon film is provided on the mold surface to prevent fusion, repeated pressing causes the adhesive strength of the thin carbon film to the molding surface to decrease, resulting in partial separation. For example, silicon carbide manufactured by CVD is dense, can be processed to a mirror surface, and has substantial resistance to oxidation at elevated temperatures, making it a promising material for pressing molds. However, when the above-described separation of the thin carbon film occurs, the extreme outer surface of silicon carbide oxidizes, causing the softened glass to fuse, and stress during cooling after pressing is known to cause the surface of the silicon carbide to develop spots (this effect is referred to as “pullout” hereinafter). When pullout occurs, the mold can no longer be used. Thus, there is an issue of extending the service life of the mold and preventing pullout by inhibiting separation of the thin carbon film.

Nor showed problems of poor external lens appearance such as fogging and the generation of minute indentations in the surface of the molded glass due to the intrusion of gas between the molding surface of the mold and the glass material being molded during press molding be avoided.

The shape and type of glass that is molded (for example, lanthanum optical glass, phosphate glass) sometimes results in problems such as a tendency to develop crizzles and cracks and deterioration of productivity. The term “crizzles” refers to fine cracks generated at portions of discontinuous surface shape of the glass element.

There is a need to discover the interrelation between the glass material being molded and the mold surface that is optimally suited to molding glass optical elements and eliminating various problems (fusion, pullout, poor lens appearance, and the like) occurring during press molding due to the effects exerted at the interface between the glass material being molded and the mold surface.

Japanese Unexamined Patent Publication (KOKAI) Heisei No. 8-259241 describes a molding surface of a mold for optical element molding that is comprised of a hard carbon film. The hard carbon film is formed with an ion beam deposition device by introducing CH₄ and H₂ into an ionization chamber, applying an acceleration voltage, drawing out an ion beam, directing it onto the molding surface, and forming a mixed layer 35 nm in thickness with the TiN film of the base material surface. Accordingly, the “Hard Carbon Film” described in Japanese Unexamined Patent Publication (KOKAI) Heisei No. 8-259241 is a film comprising a substantive amount of hydrogen, differing substantially from the carbon film formed by sputtering described in Japanese Unexamined Patent Publication (KOKAI) Showa No. 64-83529 and having the same problems as the carbon film obtained by ion plating described in Japanese Unexamined Patent Publication (KOKAI) Heisei No. 2-199036.

Additionally, the hard carbon film formed with an ion beam does not afford adequate mold separation properties and contains hydrogen, tending to result in the formation of fogging, bubbles, and indentations in the optical elements that are molded.

Further, when the blanks and pressing mold described in Japanese Unexamined Patent Publication (KOKAI) Heisei No. 8-259241 are employed, neither has adequate anti-friction property, the blanks are pressed out of position on the mold, and variation in thickness tends to develop in the optical elements that are molded.

The above-described formation of a carbon film on the surface of the pressing mold and the forming of a carbon film on the glass material being molded both afford advantages and disadvantages. Although the forming of a carbon film of some sort on the surface of the pressing mold and the glass material being molded and then using them to conduct press molding have been proposed, these molding methods do not provide adequate performance.

Accordingly, the first object of the present invention is to provide a method permitting the stable manufacturing of optical elements of good quality that eliminates various problems (fusion, pullout, poor lens appearance, and the like) occurring during press molding due to forces exerted at the interface between the glass material being molded and the pressing mold surface.

Methods of press molding high precision glass optical elements using a pressing mold that has been precisely tooled can be divided into isothermal methods of press molding in which press molding is conducted with the glass and the pressing mold at essentially equal temperature, and non-isothermal pressing methods in which press molding is begun with the glass heated to a higher temperature and the mold at a lower temperature. In isothermal methods, for example, a glass material to be molded and a mold are heated to a temperature in the vicinity of the glass softening temperature in a non-oxidizing atmosphere, the glass is pressed by the mold under a condition that the temperature of the glass material is almost the same as the temperature of the mold, and the pressure is maintained while the mold temperature is dropped below the glass transition temperature. In non-isothermal pressing methods, for example, a glass material that has been heated to a temperature corresponding to a viscosity of from 10^{5.5} to 10^{9.5} poises is press molded in a pressing mold that has been adjusted to a temperature lower than that of the glass material and corresponding to a viscosity of the glass material of 10⁷ to 10¹² poises, after which at least the temperature of the pressing mold is reduced at a cooling rate selected from within a range of from 10 to 250° C./min to a temperature below the glass transition point of the glass, followed by separation from the mold. Non-isothermal pressing methods afford the advantage of permitting a great reduction in the cycle time required to produce a single glass optical element relative to isothermal pressing methods.

However, non-isothermal pressing methods require that the glass material being molded be preheated. This preheating, for example, is advantageously conducted by heating a glass material being molded while the glass material is being floated on a gas flow over a float dish. The glass material being molded that has been softened by heating is dropped from above the molding surface of the lower mold from the float dish and then press molded. When the glass material being molded by this method is fed by dropping it at a point away from the center of the molding surface and then press molding it, variation in the thickness of the glass develops, precluding good press molded products. Accordingly, a method of inserting a funnel guiding means between the lower mold and the float dish and dropping the glass material being molded onto the lower mold by opening up a divided mold float dish horizontally in the course of dropping it from the float dish to the molding surface of the lower mold has been proposed (Japanese Unexamined Patent Publication (KOKAI) Heisei No. 11-35332). This publication further discloses correcting the position of the glass material being molded to essentially match the center point of the molding surface of the lower mold and the vertical center of the glass material being molded by a positioning means after the glass material being molded has been provided on the molding surface of the lower mold. Since the use of such a guiding means permits the stable dropping of the glass material being molded onto the molding surface of the lower mold, it prevents variation in the thickness of optical elements and prevents them from dropping out from the molding surface. Further, since the use of a positioning means permits the positioning of the glass material being molded in the center of the molding surface of the lower mold, variation in the thickness of the optical material can be prevented.

Further, investigation conducted by the present inventors has revealed that even when the above-described guiding means and positioning means are employed, there is still sometimes variation in the thickness of the glass, precluding improvement in yield. Even when the glass material being molded was guided to the center of the molding surface of the lower mold with the guiding means and positioning means, when the glass material being molded was aspherical, it did not move to the center of the molding surface of the lower mold, but sometimes leans against the guiding means or positioning means and was sometimes pressed when positioned away from the center of the molding surface.

Accordingly, the second object of the present invention is to provide a method of manufacturing glass optical elements comprising dropping a glass material onto the molding surface of a lower mold and press molding the glass material, permitting the ready guiding of the glass material being molded to the center of the molding surface of the lower mold, and as a result, preventing variation in the thickness of the glass.

The present inventors discovered that various films (structures, components, surface states) are present on the carbon film and these properties vary greatly with the manufacturing method. Further, they discovered that the use of the film materials best suited to the pressing mold and to the glass material being molded eliminated various problems (fusion, pullout poor lens appearance, and the like) occurring during press molding due to forces working at the interface between the glass material being molded and the mold surface and permitted the stable manufacturing of high-quality optical elements; Mode 1 of the manufacturing method of the present invention was devised on that basis.

They further discovered that providing a carbon film of prescribed film properties on both the pressing mold and glass material being molded prevented the glass being molded from leaning against the guiding means and the positioning means and readily permitted positioning of the glass material being molded in the center of the molding surface; Mode 2 of the manufacturing method of the present invention was devised on that basis.

### SUMMARY OF THE INVENTION

Mode 1 of the present invention relates to a method of manufacturing glass optical elements comprising:

supplying a glass material to a pressing mold, and

press molding the glass material with the pressing mold in a non-oxidizing atmosphere,

wherein the pressing mold comprises a carbon film formed by sputtering on at least a molding surface, and the glass material comprises a carbon layer on a surface thereof.

Mode 2 of the present invention relates to a method of manufacturing glass optical elements with a pressing mold comprising an upper mold and a lower mold; comprising:

supplying a glass material onto a molding surface of the lower mold by dropping, and pressing molding the glass material in a non-oxidizing atmosphere,

wherein the pressing mold comprises a carbon film formed by sputtering on at least a molding surface, and the glass material comprises a carbon layer on a surface thereof.

In Modes 1 and 2 of the present invention,

the carbon film is preferably formed by sputtering using an inert gas as a sputtering gas and graphite as a sputtering target;

the carbon film is preferably from 3 to 200 nm in thickness;

the carbon layer is preferably formed by the thermal decomposition of a hydrocarbon;

the carbon layer is preferably formed by vapor deposition;

the carbon layer is preferably from 0.1 to 2 nm in average thickness;

the pressing mold preferably comprises a portion of silicon carbide produced by CVD in at least the vicinity of the molding surface, and preferably has an intermediate layer between the silicon carbide portion and the carbon film, the intermediate layer preferably being formed by ion plating method;

the glass material that is preferably fed to the pressing mold exhibits a temperature higher than a temperature of the pressing mold;

the glass material supplied to the pressing mold is preferably heated to a temperature corresponding to a viscosity of the glass material of from 10^{5.5} to 10⁹ poises, and the pressing mold to which the glass material is fed is preheated to a temperature corresponding to a viscosity of the glass material to be molded of from 10⁷ to 10¹² poises;

feeding of the glass material to the pressing mold preferably comprises softening the glass material while floating it on a gas flow over a float dish and causing the glass material to drop onto the molding surface of the lower mold from the float dish, and the dropping of the glass material is preferably conducted employing a guiding means, and the glass material that is dropped is preferably positioned by a positioning means prior to press molding; and

the glass material preferably comprises lanthanum glass or phosphate glass.

### BRIEF DESCRIPTION OF THE FIGURES

FIG. 1 shows an embodiment (before pressing) of an optical element pressing mold employing the manufacturing method of the present invention.

FIG. 2 shows an embodiment (after pressing) of an optical element pressing mold employing the manufacturing method of the present invention.

FIG. 3 shows a schematic diagram of an ion plating device employed to form an i-carbon films.

FIG. 4 shows a schematic diagram of a sputtering device employed to form a carbon film by sputtering.

FIG. 5 shows a schematic diagram of a device for forming carbon layers by the thermal decomposition of hydrocarbon.

### BEST MODES OF THE PRESENT INVENTION

In the present invention, carbon coatings provided on a mold refer to “carbon films” or “thin carbon films” and carbon coatings provided on a glass material to be molded refer to “carbon layer” in order to avoid any confusion.

The pressing mold employed in the manufacturing methods of the present inventions (unless specifically stated otherwise, future references to the “manufacturing methods of the present invention” include both Modes 1 and 2) has a thin carbon film formed by sputtering on at least a molding surface. In contrast to i-carbon formed by ion plating, the thin carbon film formed by sputtering does not contain hydrogen and presents no problem in the form of the generation of hydrogen gas during press molding. Here, the term “molding surface” is used to mean a surface of the pressing mold coming into contact with the glass material that is molded. Further, the pressing mold comprises at least an upper and a lower mold, with thin carbon films formed by sputtering being present on both the molding surfaces of the upper and lower molds.

When the pressing mold comprises a sleeve in addition to the upper and lower mold, any portions of the sleeve that contact the glass material being molded during press molding may be coated by sputtering with a thin carbon film in advance. However, the forming of a thin carbon film by sputtering on portions of the sleeve that contact the lass element being molded may be omitted

The thin carbon film may be formed by sputtering employing an inert gas as sputtering gas and graphite as the sputtering target at a temperature of 200-450° C., for example. The formation of a thin carbon film by sputtering on the molding surface will be described below.

Sputtering is conducted with a sputtering device containing a base holder holding a press molding base and an opposing sputtering target. In the sputtering method (for example, magnetron sputtering), the temperature of the base is desirably 200 to 450° C. At greater than or equal to 200° C., relatively hard films are obtained, and at less than or equal to 450° C., the roughness of the film surface formed does not decrease. One example of the inert gas employed as sputtering gas is argon gas. Graphite is employed as the sputtering target, and a plasma is generated at high frequency to sputter the graphite and form a thin carbon film on the molding surface of the base of the pressing mold.

The thickness of the thin carbon film desirably falls within a range of from 3 to 200 nm, preferably a range of from 10 to 100 nm.

The thin carbon film has good sliding properties with the carbon layer provided on the glass material, described further below.

In the manufacturing method of the present invention, a glass material having a carbon layer on the surface thereof is employed as the glass material that is press molded. The carbon layer provided on the surface of the glass material to be molded preferably does not contain hydrogen at all or contains small amount of hydrogen. Such carbon layers can be formed by vapor deposition employing carbon materials or by thermal decomposition of hydrocarbon gasses.

When employing vapor deposition, a carbon material is heated by electron beam, direct passage of current, or an arc under a vacuum of about 10⁻⁴ Torr in a known vapor deposition device, and carbon vapor generated by evaporation and sublimation from the carbon material is transported onto the base and condensed and precipitated to form a carbon layer. For example, when employing the direct passage of current, a current of about 100 V-50 A is passed through a carbon material with a sectional surface area of 0.1 cm² to heat the carbon material electrically. The base material is desirably heated to a temperature of from room temperature to about 400° C. However, then the glass transition temperature (Tg) of the base material is less than or equal to 450° C., the upper limit to the heating temperature of the base material is desirably at Tg-50° C.

To form the carbon layer by thermal decomposition of a hydrocarbon gas, hydrocarbons are introduced into a vacuum at a prescribed temperature and decomposed into carbon and hydrogen to deposit the carbon onto the surface of the glass material to be molded.

Acetylene, ethylene, butane, ethane, and other lower hydrocarbon gases can be employed as the hydrocarbon gas; acetylene is preferred because it decomposes readily. The pressure in the reaction system during the thermal decomposition of the hydrocarbon is, for example, 10 to 200 Torr, preferably 50 to 200 Torr. The pressure may also be gradually increased or decreased as the thermal decomposition reaction progresses, or may be kept constant.

The temperature at which the carbon layer is formed by thermal decomposition of a hydrocarbon gas can be suitably determined based on the thermal decomposition temperature of the hydrocarbon employed and the softening temperature of the glass material to be molded, and usually ranges from 250 to 600° C. However, when acetylene is employed as the hydrocarbon, the forming temperature is desirably from 400 to 520° C.

Water is desirably removed prior to use from the hydrocarbon employed in thermal decomposition based on the state in which it has been stored.

The average thickness of the carbon layer provided on the glass material being molded desirably falls within a range of from 0.05 to 10 nm, preferably a range of from 0.1 to 2 nm. The average thickness of the carbon layer can bc controlled by means of the temperature during thermal decomposition, the pressure of the hydrocarbon introduced, and the processing time. When the hydrocarbon is introduced in several increments, the average layer thickness can be controlled by the number of increments.

The thickness of the carbon layer is the average value. That is, when the layer is extremely thin, it does not become a microscopically uniform layer, but the carbon sometimes forms islands which are roughly uniformly dispersed over the surface of the glass material to be molded. This state is also covered under the carbon layer referred to in the present invention.

The term “average layer thickness” as employed in the present invention means the average value of the quantity of carbon supported per unit area of the surface of the glass material to be molded. The carbon layer thickness is calculated by measuring the signal intensity of Cls from the carbon layer by electron spectroscopy for chemical analysis (ESCA), and comparing this to the signal intensity of Cls from a standard sample for which the thickness of the carbon layer on glass is known.

In the manufacturing methods of the present invention, the carbon layer provided on the glass material to be molded desirably has a hydrogen content of less than or equal to 15 at %, preferably less than or equal to 8.5 at %, and more preferably less than or equal to 5 at %. A hydrogen content of less than or equal to 15 at % affords the advantage of preventing bubbling at the interface of glass and mold due to the generation of hydrogen gas during press molding.

In addition to having a thin carbon film formed by sputtering on at least the molding surface, the pressing mold employed in the manufacturing methods of the present invention is desirably comprised of beta-type silicon carbide produced by CVD in at least the vicinity of the molding surfaces of the pressing mold, and is preferably made of beta-type silicon carbide. The use of a pressing mold comprised of beta-type silicon carbide produced by CVD in the vicinity of the molding surface permits mirror-finish processing of high quality and affords the advantage of high heat resistance.

The term “in at least the vicinity of the molding surfaces” means that the base of the pressing mold itself is made of silicon carbide by CVD, or that just the portion in the vicinity of the molding surfaces is made of silicon carbide by CVD. In one example of such a pressing mold, the base is a sintered product of silicon carbide and just the portion in the vicinity of the molding surfaces consists of silicon carbide formed by CVD.

A pressing mold having a thin carbon film formed by sputtering on at least the molding surfaces and comprised of beta-type silicon carbide produced by CVD in the vicinity of the molding surfaces can be prepared by, for example, forming a thin carbon film by sputtering, either directly or over an intermediate layer, on silicon carbide portions obtained by processing the molding surfaces to a desired shape based on the shape of the glass molded product desired. Alternatively, a silicon carbide layer can be provided by some other manufacturing method on portions formed of beta-type silicon carbide by CVD, or a layer or film of some other composition may be provided on portions formed of beta-type silicon carbide by CVD, and then a thin carbon film may be formed by sputtering thereover to prepare the pressing mold.

Examples of intermediate layers are i-carbon films formed by ion plating.

An i-carbon film can be formed by ion plating as follows. Ion plating is conducted with an ion plating device having an anode, a first cathode, and a base holder holding the base of the glass pressing mold, and a reflector positioned so as to surround the first cathode and anode. Within the ion plating device, a low voltage of from 50 to 150 V is applied between the anode and the first cathode to generate a plasma of hydrocarbon ions. When this voltage is less than 50 V, the ionization effect is low and inefficient, and when 150 V is exceeded, the plasma becomes unstable. Thus a range of 50-150 V is preferred. Further, the hydrocarbon employed is suitably selected, preferably so that the ratio of the number of carbon atoms to hydrogen atoms (C/H) is greater than or equal to 1/3. Examples are benzene (C/H=6/6), toluene (C/H=7/8), xylene (C/H=8/10), and other aromatic hydrocarbons; acetylene (C/H=2/2), methyl acetylene (C/H=3/4), butane (C/H=4/6), and other triple bond-containing unsaturated hydrocarbons; ethylene (C/H=2/4), propylene (C/H=3/6), butene (C/H=4/8), and other double bond-containing unsaturated hydrocarbons; and ethane (C/H=2/6), propane (C/H=3/8), butane (C/H=4/10), pentane (C/H=5/12), and other saturated hydrocarbons. These hydrocarbons may be employed singly or mixed for use in combinations of two or more.

A voltage of from 0.5 to 2.5 kV can be applied so that the base holder becomes the second cathode against the anode to promote the acceleration of hydrocarbon ions.

The mold base temperature during ion plating is desirably from 200 to 400° C. An i-carbon film formed within this temperature range is the most resistant to peeling.

The thickness of the i-carbon film desirably falls within a range of from 5 to 1,000 nm. At less than 5 nm, it is difficult to achieve a uniform film, and at greater than 1,000 nm, peeling tends to occur due to strain in the film.

In the present invention, a diamond film or a carbon film containing 50 percent or more of diamond structure can be provided in the vicinity of the molding surface of the pressing mold. An example of a diamond film or a carbon film containing 50 percent or more of diamond structure is a DLC film formed by the thermal filament method. Further, a diamond film or a carbon film containing 50 percent or more of diamond structure can be a carbon film formed at ordinary temperature by physical vapor deposition (PVD) employing solid carbon. A diamond film or a carbon film containing 50 percent or more of diamond structure having a density of 3.2 to 3.4 g/cm² and a hardness of Hv 6,000 to 10,000 is desirably employed. The film thickness desirably falls within a range of from 0.05 to 10 μm. The carbon film is formed on the pressing mold base, the shape thereof having been processed in advance, but if shape precision deteriorates by the formation of the carbon film, further processing can be conducted. That is, the pressing mold may be obtained by preliminarily processing the vicinity of the molding surfaces of the mold base into a prescribed shape, forming the above-described diamond film or carbon film comprising 50 percent or more of diamond structure, and then further processing the shape. The pressing mold may also have the above-described diamond film or carbon film comprising 50 percent or more of diamond structure and an intermediate layer between the base and the diamond film or carbon film, with intermediate layer being an i-carbon film formed by ion plating.

In addition to using the above-described beta-type silicon carbide formed by CVD, materials known for use in pressing molds, such as cemented tungsten carbide, may be suitably employed in the pressing mold base for the pressing mold employed in the manufacturing methods of the present invention. Alternatively, a thin film of silicon carbide may be formed in the vicinity of the molding surface, either directly or indirectly on a base material such as a cemented tungsten carbide, for example. The pressing mold base can be sintered SiC and the vicinity of the molding surfaces can be CVD SiC.

As set forth above, the pressing mold employed in the manufacturing methods of the present invention preferably may be obtained by forming an i-carbon film by ion plating on a base material comprised of silicon carbide formed by CVD, and then depositing a thin carbon layer by the above-described sputtering method.

The type of glass of the glass material to be molded that is employed in the manufacturing methods of the present invention is not specifically limited, but barium borosilicate optical glass and lanthanum optical glass are employed with particular efficacy. Barium borosilicate optical glass tends to fuse and cause pullout and lanthanum optical glass tends to crack. However, according to the manufacturing methods of the present invention, high-precision molding is possible even with these glasses.

For example, the glass composition of barium borosilicate optical glass may be characterized by glass components in the form of:

30 to 55 weight percent SiO₂,

5 to 30 weight percent B₂O₃,

where the total content of SiO₂ and B₂O₃ is from 56 to 70 weight percent and the weight ratio of SiO₂/B₂O₃ is from 1.3 to 12.0,

7 to 12 weight percent Li₂O (excluding 7 weight percent)

0 to 5 weight percent Na₂O,

0 to 5 weight percent K₂O,

where the total content of Li₂O, Na₂O, and K₂O is from 7 to 12 weight percent (excluding 7 weight percent),

10 to 30 weight percent BaO,

0 to 10 weight percent MgO,

0 to 20 weight percent CaO,

0 to 20 weight percent SrO,

0 to 20 weight percent ZnO,

where the glass contains from 10 to 30 weight percent BaO, MgO, CaO, SrO, and ZnO, and of these glass components, the total content of SiO₂, B₂O₃, Li₂O, and BaO is greater than or equal to 72 weight percent and TeO₂ is not contained.

The above-listed glass further comprising:

1 to 7.5 weight percent Al₂O₃,

0 to 3 weight percent P₂O₅,

0 to 15 weight percent La₂O₃,

0 to 5 weight percent Y₂O₃,

0 to 5 weight percent Gd₂O₃,

0 to 3 weight percent TiO₂,

0 to 3 weight percent Nb₂O₅,

0 to 5 weight percent ZrO₂, and

0 to 5 weight PbO

is also suitably employed.

Specific examples of the glass material being molded are a glass material comprising 37.8 percent SiO₂, 24.0 weight percent B₂O₃, 5.3 weight percent Al₂O₃, 8.5 weight percent Li₂O, 5.0 weight percent CaO, 16.1 weight percent BaO, 3.3 weight percent La₂O₃, 0.5 weight percent As₂O₃, and 0.2 weight percent Sb₂O₃ with a Tg of 500° C.; and a glass material comprising 41.2 percent SiO₂, 19.5 weight percent B₂O₃, 5.2 weight percent Al₂O₃, 9.0 weight percent Li₂O, 16.1 weight percent BaO, 9.0 weight percent La₂O₃, 0.5 weight percent As₂O₃, and 0.2 weight percent Sb₂O₃ with a Tg of 495° C.

Examples of lanthanum optical glasses are optical glasses comprising glass components of the following weight percentages: 25 to 42 percent B₂O₃, 14 to 30 percent La₂O₃, 2 to 13 percent Y₂O₃, 2 to 20 percent SiO₂O, more than 2 percent and not more than 9 percent Li₂O, 0.5 to 20 percent CaO, 2 to 20 percent ZnO, 0 to 8 percent Gd₂O₃, 0 to 8 percent ZrO₂, and 0.5 to 12 percent Gd₂O₃+ZrO₂, with these components comprising not less than 90 percent of the total content. In some cases, the glass may also comprise 0 to 5 percent Na₂O, 0 to 5 percent K₂O, 0 to 5 percent MgO, 0 to 5 percent SrO, 0 to 10 percent BaO, 0 to 10 percent Ta₂O₅, 0 to 5 percent Al₂O₃, 0 to 5 percent Yb₂O₃, 0 to 5 percent Nb₂O₅, 0 to 2 percent As₂O₃, and 0 to 2 percent Sb₂O₃.

The above-described glass desirably comprises the essential components, given as weight percentages, of 27 to 39 percent boron oxide, 16 to 28 percent lanthanum oxide, 4-12 percent yttrium oxide, 4 to 18 percent silicon oxide, 2.5 to 8 percent lithium oxide, 1 to 18 percent calcium oxide, 3 to 18 percent zinc oxide, 0 to 6 percent gadolinium oxide, 0 to 7 percent zirconium oxide, with a combined 0.5 to 11 percent of gadolinium oxide and zirconium oxide and with these essential components constituting greater than or equal to 92 percent of the total content. The above described optical glass further comprises optional components, given as weight percentages, of 0 to 3 percent sodium oxide, 0 to 3 percent potassium oxide, 0 to 3 percent magnesium oxide, 0 to 3 percent strontium oxide, 0 to 7 percent barium oxide, 0 to 3 percent tantalum oxide, 0 to 3 percent aluminum oxide, 0 to 3 percent ytterbium oxide, 0 to 3 percent niobium oxide, 0 to 2 percent arsenic oxide, and 0 to 2 percent antimony oxide.

A specific example of a glass material to be molded comprises: 15 weight percent SiO₂, 28 weight percent B₂O₃, 3 weight percent Li₂O, 11 weight percent CaO, 21 weight percent La₂O₃, 8 weight percent Y₂O₃, 8 weight percent ZnO, and 6 weight percent ZrO₂, with a Ts (sag point) of 590° C. The glass material to be molded can be comprised of barium borosilicate glass with a carbon layer preferably of 0.05 to 1 nm in thickness. Additionally, the glass material to be molded can be comprised of lanthanum glass or phosphate glass with a carbon layer preferably of 1 to 2 nm in thickness.

The shape of the glass optical element manufactured by the manufacturing methods of the present invention is not specifically limited. However, when manufacturing a glass optical element having at least one convex surface, the effect of the present invention is marked. The effect is particularly great when manufacturing a glass optical element having at least one convex surface out of lanthanum optical glass. Further examples of glass optical elements for which the manufacturing methods of the present invention are effective se biconvex lenses and convex meniscus lenses with thin edges.

In the manufacturing methods of the present invention, a glass material to be molded having a carbon layer on its surface is press molded in a pressing mold having a thin carbon film formed by sputtering on at least the molding surfaces. In this process, the press molding is conducted under a non-oxidizing atmosphere. Examples of non-oxidizing atmospheres are a nitrogen gas, a mixture gas of nitrogen and hydrogen comprising a few percent of hydrogen, and an argon gas.

Known press molding methods and conditions employed in methods of manufacturing glass optical elements may be applied as the methods and conditions of press molding in the manufacturing methods of the present invention. Isothermal pressing methods and non-isothermal pressing methods may be applied to the manufacturing methods of the present invention.

Isothermal pressing is a method of press molding with the glass material and pressing mold at essentially the same temperature. Specifically, the glass material and the mold are heated to the vicinity of the softening point of the glass in a non-oxidizing inert atmosphere, the glass is pressed by the mold with the glass material being molded and the mold at almost the same temperature, and while maintaining the pressure, the mold temperature is decreased to below the glass transition temperature. In isothermal pressing, good shape transfer of the pressing mold surface and shape precision are readily achieved. However, the cycle time of molding is longer than that of non-isothermal pressing.

Non-isothermal pressing is a method in which press molding is begun with the glass temperature high and the mold temperature lower than the glass temperature. Specifically, a glass material to be molded that has been heated to where it assumes a viscosity of 10^{5.5} to 10^{9.5} poises is press molded in a pressing mold the temperature of which has been adjusted to a temperature lower than the glass temperature and corresponding to a glass material viscosity of 10⁷ to 10¹² poises, cooling is conducted at a rate selected from within a range of from 10 to 250° C./min to bring at least the temperature of the pressing mold to below the glass transition point, and separation from the mold is conducted. In non-isothermal pressing, the cycle time is much shorter than that of isothermal pressing.

The temperature of the glass material to be molded is desirably one corresponding to a glass viscosity of 10^{6.5} to 10⁸ poises, and die mold temperature is desirably one corresponding to a glass viscosity of 10^{7.5} to 10¹⁰ poises. The cooling rate is preferably 20 to 100° C./min.

In the above-described non-isothermal method, preheating of the glass material to be molded is necessary before press molding. In the course of preheating, and/or in the course of transferring a glass material to be molded that has been softened by heating onto the pressing mold, floating by means of a gas flow on a float dish and preheating and transferring the glass material being molded so that the glass material being molded is in a contact-free state are desirable.

The glass material being molded can be softened while being floated on a gas flow over a float dish, transferred to directly above the lower mold, and then dropped from the float dish to the lower mold and press molded.

In Mode 2 of the present invention in particular, the glass material being molded is dropped onto the molding surface of the lower mold of a pressing mold comprising at least an upper mold and a lower mold, after which the glass material being molded is press molded by the pressing mold.

Since the molding surface of the lower mold is coated with a carbon thin film by sputtering and the surface of the glass material being molded has been covered with a carbon layer, Mode 2 of the present invention affords heretofore unknown advantages such as good sliding on the molding surface and ready movement to a prescribed position of the glass material being molded that has been dropped onto the molding surface of the lower mold. However, these effects are limited to when a thin carbon film is formed by sputtering on the molding surface and a carbon layer is formed on the surface of the glass material being molded. This point will be elaborated in the Examples later.

As mentioned further below, permitting ready movement of the glass material being molded to a prescribed position is particularly effective when dropping of the glass material being molded is conducted with a guiding means and when the glass material being molded is positioned on the molding surface by a positioning means. In both cases, the glass material being molded is positioned at a prescribed spot (the center) on the molding surface of the lower mold, variation in thickness is prevented because of uniform extension within the mold during pressing, and accordingly, jutting of the glass material out of the mold and the production of defective products are prevented,

When employing a non-isothermal pressing method in the manufacturing methods of the present invention, it is effective to float the preheated glass material being molded over a float dish with a gas flow and drop it onto the pressing mold in a contact-free state. In this process, a guiding means placed between the float dish and the lower mold can be employed so that the glass material being molded is correctly dropped from the float dish into the center of the lower mold. The guiding means has a guide member forming a drop path for the glass material being molded and causing the glass material being molded to drop essentially vertically. A desirable guiding means is in the form of a funnel having a shape with at least one portion that narrows the drop path of the glass material in a downward direction. The funnel guiding means is desirably inserted between the lower mold and the float dish so that when dropping the glass material from the float dish to the lower mold, a split-type float dish can be opened horizontally to effect dropping the glass material onto the lower mold. The material of the guiding means is not specifically limited other than that it be heat resistant, it being possible to use metals, ceramics, and carbon materials. The preferred material of the guiding means is high-density carbon, or high-density carbon the surface of which has been treated to achieve glassy carbon.

In the course of providing the glass material being molded onto the molding surface of the lower mold, it is possible to correct the position of the glass material being molded. Specifically, following placement of the glass material being molded on the molding surface of the lower mold, it is desirably to correct the position of the glass material being molded with a positioning means so that the vertical center of the glass material and the center point of the molding surface of the lower mold essentially match. Thus, the glass material being molded is positioned at a prescribed spot on the mold (the center) and variation in thickness is prevented due to uniform extension within the mold during pressing. Accordingly, the glass material being molded is prevented from jutting out of the mold and the production of defective products is avoided. The positioning means may be ring-shaped, chuck-shaped, or the like, and a chuck-shaped positioning means constricting from both sides is desirably employed. The material of the positioning means is not specifically limited other than that it be heat resistant. Metals, ceramics, and carbon materials may be employed. The preferred material of the positioning means is high-density carbon, or high-density carbon the surface of which has been treated to form glassy carbon. The positioning means is desirably employed at a high temperature but lower than the pressing mold temperature.

The above-described funnel guiding means and positioning means are disclosed in Japanese Unexamined Patent Publication (KOKAI) Heisei No. 11-35332, for example.

Following press molding in the manufacturing methods of the present invention, the carbon layer applied to the glass material to be molded can be removed by an oxidation treatment. In removal by oxidation, the glass molded product to be oxidation treated is placed at a prescribed temperature of, for example, 250° C. or higher, in an oxidizing atmosphere at or below the glass strain point. Oxygen plasma ashing and other methods of oxidation treatment may also be employed as the removal method.

Further, following press molding, the glass molded product can be maintained for a prescribed period in an oxidizing atmosphere 10° C. below the glass transition point and above the strain point of the glass, and then cooled at a prescribed cooling rate to simultaneously remove the carbon layer, remove strain, and adjust the refractive index. The cooling rate to 30° C. below the stain point is desirably from 10 to 80° C./hr.

### EXAMPLES

### Example 1

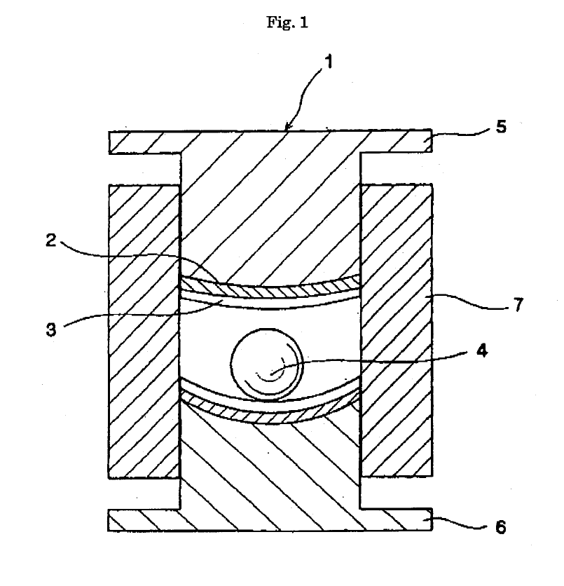

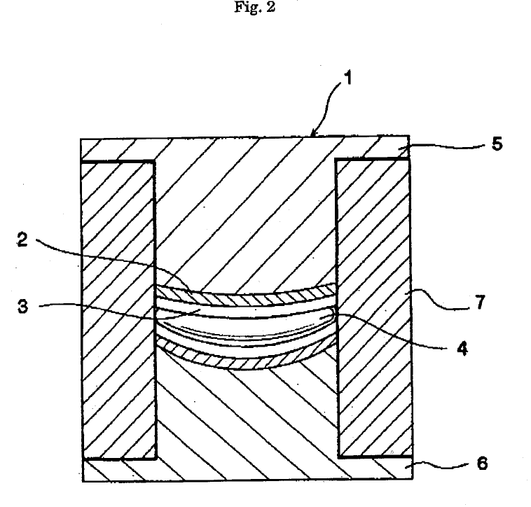

FIGS. 1 and 2 show an embodiment of a mold for optical element molding by the manufacturing methods of the present invention. FIG. 1 shows the status before pressing and FIG. 2 the status after pressing. In FIG. 1, 1 denotes a pressing mold the entire mold base of which is comprised of beta-type silicon carbide produced by CVD, 2 denotes an intermediate layer comprised of i-carbon formed by ion plating, 3 denotes a thin carbon film formed by sputtering and constituting the outermost layer of the pressing mold, and 4 denotes a glass material being molded the surface of which is covered with a carbon layer formed by thermal decomposition of acetylene. By press molding glass material being molded 4 in the mold shown in FIG. 2, a convex meniscus lens with a pressing outer diameter of 16 mm, a center thickness of 3 mm, and an edge thickness of 0.8 mm is obtained in the present embodiment.

The optical element pressing mold employed in the present embodiment will be described next in detail. Beta-type silicon carbide prepared by CVD was processed to specified shape as the mold base. The molding surfaces were finished to the shape precision and surface roughness required of lenses. An i-carbon film was then coated by ion plating on the molding surfaces.

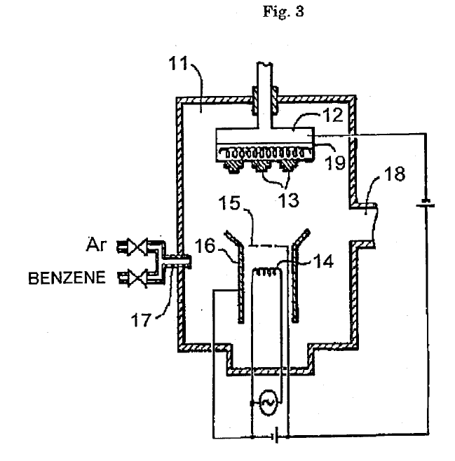

FIG. 3 is a schematic view of an ion plating device employed to form i-carbon films. In the ion plating device shown in FIG. 3, a base holder 12 with built-in heater 19 is positioned above a vacuum vessel 11, holding a pressing mold base 13 comprised of silicon carbide formed by CVD. A first cathode 14 comprising of tantalum (Ta) filaments and an anode 15 comprised of a base of tungsten (W) are provided beneath and opposite base holder 12. A cylindrical reflector 16 surrounding electrodes 14 and 15 is provided. The goal is to concentrate ions produced by this assembly toward base 13. In the figure, 17 denotes an argon and benzene gas introduction inlet and 18 denotes an exhaust outlet for vacuum discharge.

Once a vacuum of 5.0×10⁻⁶ Torr has been generated within vacuum vessel 11 through exhaust outlet 18, argon gas was introduced through gas introduction inlet 17 to maintain the vacuum at 3.0×10⁻⁴ Torr, a voltage of 80 V was applied between first cathode 14 and anode 15, plasma was generated therebetween, and argon gas was ionized by thermoelectrons from first cathode 14. A voltage of 1.5 kV was applied between the second cathode in the form of base holder 12 and anode 15, a voltage of 80 V was applied to reflector 16, and argon ions were accelerated in a concentrated manner toward base 13 to bombard and clean the surface of base 13.

Vacuum vessel 11 was then re-evacuated and benzene gas was introduced through gas inlet 17 to maintain a vacuum of 2.0×10⁻³ Torr. A voltage of 80 V was applied between first cathode 14 and anode 15 to convert the benzene gas to hydrogen carbide ions. A voltage of 1.5 kV was then applied between the second cathode in the form of base holder 12 and anode 15 and a voltage of 80 V was applied to reflector 16 to accelerate in a concentrated manner hydrogen carbide ions toward pressing mold base 13, forming an i-carbon film 40 nm thick on the surface of pressing mold base 13 preheated to 300° C.

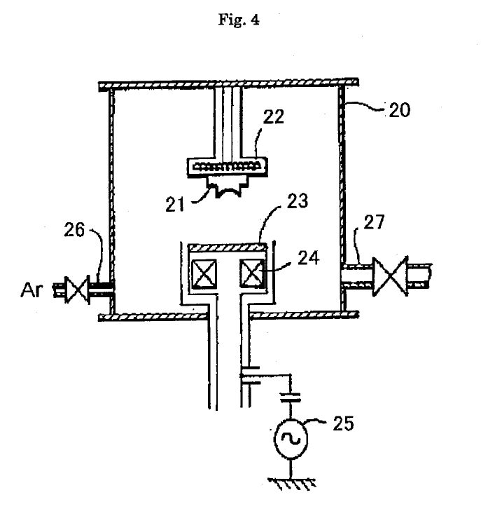

FIG. 4 shows a schematic diagram of the sputtering device employed to form a thin carbon film by sputtering on the i-carbon film. In the sputtering device shown in FIG. 4, a base holder 22 with a built-in heater is provided at the top of vacuum vessel 20, holding pressing mold base 21 that has been coated with an i-carbon film. A target 23 of graphite is positioned opposite pressing mold base 21 at the bottom of vacuum vessel 20. In the figure, 24 denotes a magnet, 25 an RF source with a frequency of 13.56 MHz, 26 denotes an argon gas inlet, and 27 denotes a vacuum exhaust outlet.

After the interior of vacuum vessel 20 had been evacuated to a vacuum of 5.0×10⁻⁵ Torr through exhaust outlet 27, argon gas was introduced through gas inlet 26 to maintain a vacuum of 5.0×10⁻³ Torr, a high-frequency voltage was applied by RF source 25 to sputter graphite target 23, and a thin carbon film was formed to a thickness of 30 nm on the i-carbon film of pressing mold base 21, which had been preheated to 300° C.

In this manner, as shown in FIGS. 1 and 2, ion plating was used to form an i-carbon film 2 over a beta-type silicon carbide pressing mold formed in a prescribed shape by CVD, and sputtering was used to form a thin carbon film 3 over i-carbon film 2, yielding the glass pressing mold employed in the present embodiment.

A carbon layer was formed by acetylene thermal decomposition on a glass material to be molded (hot shaped into an oblate sphere) comprised of barium borosilicate optical glass (basic composition: 37.8 weight percent SiO₂, 24.0 weight percent B₂O₃, 5.3 weight percent Al₂O₃, 8.5 weight percent Li₂O, 5.0 weight percent CaO, 16.1 weight percent BaO, 3.3 weight percent La₂O₃, 0.5 weight percent As₂O₃, and 0.2 weight percent Sb₂O₃ with a Tg of 500° C. and a Ts of 540° C.). The method is described below.

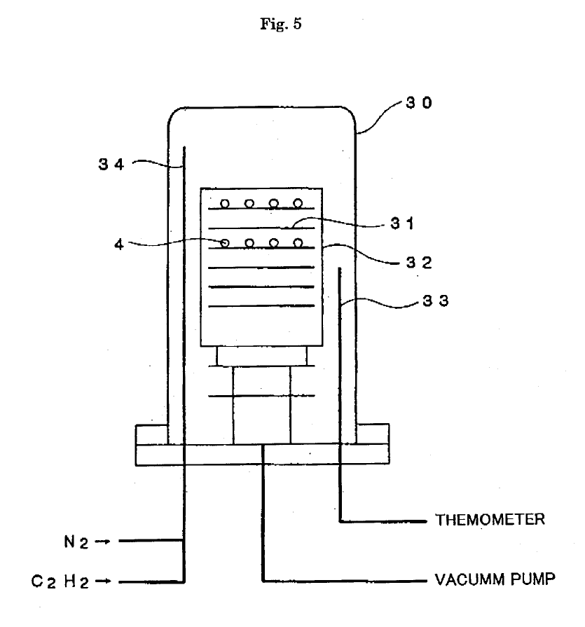

Glass material to be molded 4 was positioned on a tray made of quartz 31 and placed in the bell jar 30 shown in FIG. 5. In FIG. 5, 32 is a rack, 33 is a thermocouple and 34 is a gas inlet. The interior of the bell jar was evacuated to 0.5 Torr or less maintained at 480° C. by heating, Nitrogen gas was introduced through gas inlet 34 while evacuating with a vacuum pump to maintain 160 Torr, and a 30 min purge was conducted. The introduction of nitrogen gas was stopped and tie bell jar was evacuated to 0.5 Torr. Subsequently, the valve connected to the evacuation system was closed and acetylene was introduced continuously for 100 min at a flow rate of 65 sccm until the pressure reached 120 Torr. When the prescribed pressure had been reached, heating and the introduction of acetylene were halted, and a vacuum was generated. Once the temperature dropped, the glass material being molded was removed. ESCA was used to measure the Cls signal intensity for comparison with a base sample of known carbon film thickness, revealing a layer thickness of 0.6 nm on average.

Next, as set forth above, multiple pieces of glass material with carbon layers were prepared and press molded with the above-described pressing mold. As shown in FIGS. 1 and 2, the process of positioning a glass material for molding 4 between an upper mold 5, lower mold 6, and sleeve 7, pressing it for 60 sec at a pressure of 100 Kg/cm² corresponding to a glass viscosity of 107.6 poises in a nitrogen atmosphere, cooling it at a cooling rate of 80° C./min to the glass transition temperature, further cooling it, and removing it was repeatedly conducted. In this process, after each 500 cycles of press molding, the i carbon film provided on the pressing mold and the thin carbon film provided by sputtering thereover were removed by oxidation processing in the form of oxygen plasma ashing (and the oxide layer formed on the surface is also removed), and the same method and conditions as set forth above were used to form an i-carbon film and sputter a thin carbon film. Table 1 gives the pressing results of Examples 2 to 4 and Comparative Examples.

Since the carbon adhered to the molded glass product following press molding, the molded glass product was maintained for 2 hr in air at 20° C. below the glass transition point and then cooled at a cooling rate of 50° C./hr to remove the carbon layer, remove strain, and adjust the refractive index. As is clear from Table 1, there were no abnormalities, the surface precision of the molded glass product was good, and there was no problem (fogging, gas bubbles, or the like) with outer appearance in 50,000 press cycles.

### Comparative Example 1

With the exception that no carbon layer was applied to the surface of the glass material being molded, press molding was conducted by the same method as in Example 1. Strain removal and refractive index adjustment were conducted in the same manner as in Example 1. Pullout occurred at 5,000 cycles on average.

### Example 2

Press molding was conducted by the same method as in Example 1 with the exception that no intermediate layer of i-carbon film was provided in the pressing mold. As indicated in Table 1, in contrast to Example 1, pullout occurred on average every 10,000 cycles. The mold service life was shorter than in Example 1, but in contrast to Comparative Example 1, the effect of the present invention was clearly achieved,

### Example 3

In the present embodiment, a silicon carbide pressing mold base by CVD was processed into shape by CVD, a DLC film (a carbon film of diamond structure, a part of which had a graphite structure) was formed to 2 micrometers, and the base was ground into the final desired shape. A surface layer in the form of a thin carbon film was then formed by the same sputtering method as in Example 1. The DLC film was formed by PVD with solid carbon.

A carbon layer was formed on the glass material being molded in the same manner as in Example 1. In the present embodiment, the thin carbon film formed by sputtering was removed by plasma ashing and a new film formed each 500 press molding cycles. In this process, the diamond film was not removed by plasma ashing, but used repeatedly. The pressing results shown in Table 1 indicate no abnormalities in the mold for 50,000 pressing cycles.

### Example 4

With the exception that the pressing mold base comprised of silicon carbide formed by CVD was replaced with a cemented tungsten carbide pressing mold containing no metal binder, press molding was conducted in the same manner as Example 3 and results similar to those of Example 3 were obtained.

### Comparative Examples 2 to 6

With the exceptions that no carbon layer was coated onto the surface of the glass material being molded or a pressing mold not having a thin carbon film and/or intermediate film was employed, press molding was conducted in the same manner as in Example 1. The results are given in Table 1.

TABLE 1

| | Pressing Mold | | | | |
|---|---|---|---|---|---|
| | Base material | Intermediate layer | Surface layer | Molded Glass | Results of Pressure Molding |
| Example | CVDSiC | i-carbon film | Thin carbon film | Carbon layer | No abnormalities in 50,000 press |
| 1 | | (40 nm thick) | (30 nm thick) | | molding cycles |
| Example | CVDSiC | None | Thin carbon film | Carbon layer | Pullout occurred on average each |
| 2 | | | (70 nm thick) | | 10,000 cycles of press molding. |
| Example | CVDSiC | DLC film | Thin carbon film | Carbon layer | No abnormalities in 50,000 press |
| 3 | | (2 micrometers | (30 nm | | molding cycles |
| | | thick) | | | |
| Example | Cemented | DLC film (same as | Thin carbon film | Carbon layer | No abnormalities in 50,000 press |
| 4 | carbide | above) | (same as above) | | molding cycles |
| Comp. | CVDSiC | i-carbon film (40 | Thin carbon film | None | Pullout occurred on average each 5,000 |
| Ex. 1 | | nm thick) | (30 nm) | | cycles of press molding. |
| Comp. | CVDSiC | None | Thin carbon film | None | Separation and pullout occurred after |
| Ex. 2 | | | (70 nm thick) | | the 500 initial pressing cycles. |
| Comp. | CVDSiC | i-carbon film (70 | None | None | Poor appearance, with minute |
| Ex. 3 | | nm thick) | | | indentation and fogging. |
| | | | | | Pullout occurred on average each 1,000 |
| | | | | | cycles of press molding. |
| Comp. | CVDSiC | None | None | None | Fusion and pullout in several spots |
| Ex. 4 | | | | | occurred during the first pressing cycles. |
| Comp. | CVDSiC | None | None | Carbon layer | Pullout occurred on average each |
| Ex. 5 | | | | | several cycles of press molding. |
| Comp. | CVDSiC | i-carbon film (70 | None | Carbon layer | Poor appearance, with minute |
| Ex. 6 | | nm thick) | | | indentation and fogging. |

Table 1 gives the results of Examples 1 to 4 and Comparative Examples 1 to 6. In Comparative Example 1, pullout occurred on average each 5,000 pressing cycles and the pressing mold could not be used. The other comparative examples also presented problems such as fusion and poor appearance due to pullout and fogging. By contrast, in Examples 1 to 4, no abnormalities occurred in at least 10,000 pressing cycles. Further, in Examples 1 to 4, the molded glass product presented no problems in quality of external appearance, surface precision, or the like.

### Example 5

In the present invention, a glass material to be molded (hot molded into an oblate spherical shape) comprised of lanthanum optical glass (basic composition: 7.0 weight percent SiO₂, 34.0 B₂O₃, 3.5 weight percent Li₂O, 7.5 weight percent CaO, 9.0 weight percent ZnO, 24.0 weight percent La₂O₃, 8.0 weight percent Y₂O₃, 3.0 weight percent Gd₂O₃, and 4.0 weight percent ZrO₂ (Tg: 530° C., Ts: 570° C.)) was press molded into the same lens shape as in Example 1.

A two layer film was formed on the pressing mold by the same method as in Example 1. First, when press molding was conducted without providing a carbon layer on the glass material being molded, crizzles and cracks appeared on the press molded product and press molding was difficult. Accordingly, a carbon layer was formed on the surface of the glass material being molded by the same acetylene thermal decomposition method as in Example 1 for press molding. When press molding was conducted by the same method as in Example 1, there was a marked effect on preventing cracking, but crizzles occurred at a rate of about once every 20 cycles. Accordingly, the average carbon layer thickness was made 1.2 nm. As a result, the occurrence of both crizzles and cracks was completely inhibited and quality lenses were stably produced. Further, the carbon film exhibited the advantageous effects of preventing crizzles and cracks because the frictional resistance due to contraction of the glass following pressing was reduced and glass stress did not increase to high levels. By contrast, when there was no carbon layer, the curved surfaces of the optically functional surfaces of the optical elements developed arc-shaped crizzles (cracks), with some optical elements splitting in two. This was attributed to significant stress during glass contraction caused by adhesion between the glass material being molded and the mold.

### Examples 6 to 9

Lanthanum optical glass (identical to that of Example 5, hot molded into oblate spheres) was employed as the glass material being molded. Either the funnel guiding means of Example 1 or the positioning means of Example 2 in Japanese Unexamined Patent Publication (KOKAI) Heisei No. 11-35332 was also employed to mold biconvex lenses with a pressing diameter of 14 mm, a center thickness of 4 mm, and an edge thickness of 2 mm. The funnel guiding means and the positioning means employed had glassy carbon surfaces obtained by treatment of high-density carbon.

As a result, the results shown in Table 2 were obtained. In the table, the term “Poor” employed for the funnel guiding means of (1) denotes that significant variation in thickness precluding use as an optical element occurred in 10 percent or more of the samples. This was attributed to the glass material being molded falling at an angle onto the pressing mold, leaning against the funnel guiding means, and being press molded in that position when the guiding means was removed. The term “Good” denotes that the above-described defective sample rate was less than 1 percent. In other words, the glass material being molded slid when it dropped onto the pressing mold, moving to roughly the center position and yielding good press molding results.

The term “Poor” used for the positioning means of (2) denotes that 10 percent or more of samples fell at a position away from the center of the lower mold, remained there, could not be smoothly moved by the positioning means, and assumed a distorted shape during subsequent press molding. The term “Good” denotes that the rate of such defective samples was less than 1 percent. In other words, the samples were smoothly slid by the positioning means to the center position, yielding good lenses in subsequent press molding.

The lenses presented no problems such as crizzles or cracks due to their thick edges.

TABLE 2

| | | | | (1) Funnel guiding means | | (2) Positioning means | |
|---|---|---|---|---|---|---|---|
| | | | | employed | | employed | |
| | | | | (Corresponding to | | (Corresponding to | |
| | | | | Example 1 in Japanese | | Example 2 in Japanese | |
| Pressing Mold | | | | Unexamined Patent | | Unexamined Patent | |
| Base | | | | Publication (KOKAI) | | Publication (KOKAI) | |
| material | Intermediate layer | Surface layer | Glass being molded | Heisei No. 11-35332) | | Heisei No. 11-35332) | |
| CVDSiC | i-carbon film (40 | Thin carbon | Carbon layer | Example 6 | Good | Example 8 | Good |
| | nm thick) | film (30 nm | | | | | |
| | | thick) | | | | | |
| CVDSiC | None | Thin carbon | Carbon layer | Example 7 | Good | Example 9 | Good |
| | | film (70 nm | | | | | |
| | | thick) | | | | | |
| CVDSiC | i-carbon film (70 | None | Carbon layer | Comparative | Poor | Comparative | Poor |
| | nm thick) | | | Example 7 | | Example 11 | |
| CVDSiC | i-carbon film (40 | This carbon | None | Comparative | Poor | Comparative | Poor |
| | nm thick) | film (30 nm | | Example 8 | | Example 12 | |
| | | thick) | | | | | |
| CVDSiC | None | This carbon | None | Comparative | Poor | Comparative | Poor |
| | | film (70 nm | | Example 9 | | Example 13 | |
| | | thick) | | | | | |
| CVDSiC | i-carbon film (70 | None | None | Comparative | Poor | Comparative | Poor |
| | nm thick) | | | Example 10 | | Example 14 | |

Good results were achieved in Examples 6 to 9.

By contrast, in the pressing molds in which only i-carbon was coated on the molding surface (outer surface), shown in Comparative Examples 7 and 11, there 3 as poor sliding even when a carbon layer was formed on the glass material being molded and variation in thickness thus tended to occur. Further, in Comparative Examples 8, 9, 10, 12, 13, and 14, in which no carbon layer was formed on the glass material being molded, variation in thick ness occurred.

In the present invention, the interaction of a thin carbon film on the molding surface of a mold and a carbon layer on the surface of a glass material in a prescribed molding method alleviate the forces (particularly adhesive and frictional forces) at the interface and cause the layer on the molding surface to tend not to separate. Accordingly, there is no pullout problem and the service life of the mold is greatly increased. Further, based on the present invention, no minute indentations or fogging occurs at the interface in the press, improving surface precision.

Even in glasses in which crizzles and cracks tends to occur, that is, glasses imposing strict manufacturing conditions, the method of the present invention alleviates forces exerted at the interface between the pressing mold and the glass material being molded, eliminating the problems of crizzles and cracks. That is, frictional resistance is reduced and stress is prevented from increasing during contraction of the glass following pressing, yielding good results. For example, in glasses (for example, lanthanum optical glasses) tending to develop crizzles and cracks, it is possible to obtain without problem an optical element of desired shape (convex shapes, particularly shapes with thin edges) based on the present invention since the forces developing within the glass are alleviated.

Further, in the present invention, the interaction between the carbon layer on the surface of the glass material being molded and the thin carbon film formed by a specific method on the mold molding surface causes the glass material being molded that is fed onto the mold to move smoothly within the mold, tending to be guided into the center. Thus, defects due to variation in thickness tend not to occur.

Further, the carbon layer has good flexibility to follow deformation of the glass and good extension properties. When the glass is subjected to pressure by the molding surfaces and deforms, the carbon layer is thought to tend to slide, thereby reducing resistance and permitting extension.

The present disclosure relates to the subject matter contained in Japanese Patent Application No. 2002-42287 filed on Feb. 19, 2002, which is expressly incorporated herein by reference in its entirety.

What is claimed is:

1. A method of manufacturing glass optical elements comprising:
supplying a glass material to a pressing mold, and
press molding the glass material with the pressing mold in a non-oxidizing atmosphere,
wherein the pressing mold comprises a carbon film formed by sputtering on at least a molding surface, and the glass material comprises a carbon layer on a surface thereof.

2. A method of manufacturing glass optical elements with a pressing mold comprising an upper mold and a lower mold; comprising:
supplying a glass material onto a molding surface of the lower mold by dropping, and pressing molding the glass material in a non-oxidizing atmosphere,
wherein the pressing mold comprises a carbon film formed by sputtering on at least a molding surface, and the glass material comprises a carbon layer on a surface thereof.

3. The method of claim 1, wherein said carbon film is formed by sputtering using an inert gas as a sputtering gas and graphite as a sputtering target.

4. The method of claim 1, wherein said carbon film is from 3 to 200 nm in thickness.

5. The method of claim 1, wherein said carbon layer is formed by the thermal decomposition of a hydrocarbon.

6. The method of claim 1, wherein said carbon layer is formed by vapor deposition.

7. The method of claim 1, wherein said carbon layer is from 0.1 to 2 nm in average thickness.

8. The method of claim 1, wherein said pressing mold comprises a portion of silicon carbide produced by CVD in at least the vicinity of the molding surface.

9. The method of claim 8, wherein said pressing mold comprises an intermediate layer between said silicon carbide portion and said carbon film.

10. The method of claim 9, wherein said intermediate layer is formed by ion plating method.

11. The method of claim 1, wherein the glass material supplied to the pressing mold has a temperature higher than a temperature of the pressing mold.

12. The method of claim 1 further comprising heating the glass material to a temperature corresponding to a viscosity of the glass material of from 10^{5.5} to 10⁹ poises, and heating the pressing mold to a temperature corresponding to a viscosity of the glass material of from 10⁷ to 10¹² poises, before supplying the glass material to the pressing mold.

13. The method of claim 12, wherein the glass material is softened while floating on a gas and is supplied to the pressing mold by dropping.

14. The method of claim 13, wherein the position of the supplied glass material is controlled by dropping the glass material employing a guiding means or by correcting the position of the material by a positioning means.

15. The method of claim 1, wherein said glass material comprises lanthanum glass or phosphate glass.

16. The method of claim 2, wherein said carbon film is from 3 to 200 nm in thickness.

17. The method of claim 2, wherein said carbon layer is formed by vapor deposition.

18. The method of claim 2, wherein said carbon layer is from 0.1 to 2 nm in average thickness.

19. The method of claim 2, wherein the glass material supplied to the pressing mold has a temperature higher than a temperature of the pressing mold.

20. The method of claim 2, wherein the position of the supplied glass material is controlled by dropping the glass material employing a guiding means or by correcting the position of the material by a positioning means.
